(19) United States
(12) Patent Application Publication
(10) Pub. No.: US 2022/0274444 A1
(43) Pub. Date: Sep. 1, 2022

(54) TIRE COMPRISING A TREAD

(71) Applicant: COMPAGNIE GENERALE DES ETABLISSEMENTS MICHELIN, Clermont-Ferrand (FR)

(72) Inventors: BERTRAND BOISDON, Clermont-Ferrand (FR); MARIE-HELENE VANTAL, Clermont-Ferrand (FR)

(21) Appl. No.: 17/630,192

(22) PCT Filed: Jul. 27, 2020
(86) PCT No.: PCT/FR2020/051372

§ 371 Date: Jan. 26, 2022

(30) Foreign Application Priority Data
Jul. 26, 2019 (FR) FR1908517

(51) Int. Cl. B60C 1/00; B60C 11/03; B60C 11/12; C08L 9/06

(52) U.S. Cl. CPC B60C 1/0016; B60C 11/0302; B60C 11/12; C08L 9/06; B60C 2011/0025

(57) ABSTRACT

A tire comprises a directional tread (10), said tread comprising a central axis (12) and two edges (14A, 14B) a tread width W being greater than or equal to 140 mm, said tread (10) comprising a plurality of patterns (13) which succeed one another in the circumferential direction, each pattern having a pitch P, the patterns (13) delimiting a plurality of oblique grooves (16A, 16B), each oblique groove extending from one of the edges (14A, 14B) of the tread as far as the central axis (12). In a central part of the tread centered on the central axis (12) and of a width corresponding to 80% of the width W of said tread, all or some of the oblique grooves (16A, 16B) of the plurality of oblique grooves have a prescribed slenderness ratio, and all or some of the patterns comprise at least one sipe and have a prescribed sipes density SD.

### TECHNICAL FIELD

The present invention relates to a tyre for a motor vehicle of which the tread comprises a plurality of oblique grooves exhibiting a high slenderness ratio. The invention is more particularly suited to a tyre intended to be fitted to a passenger vehicle or van.

### PRIOR ART

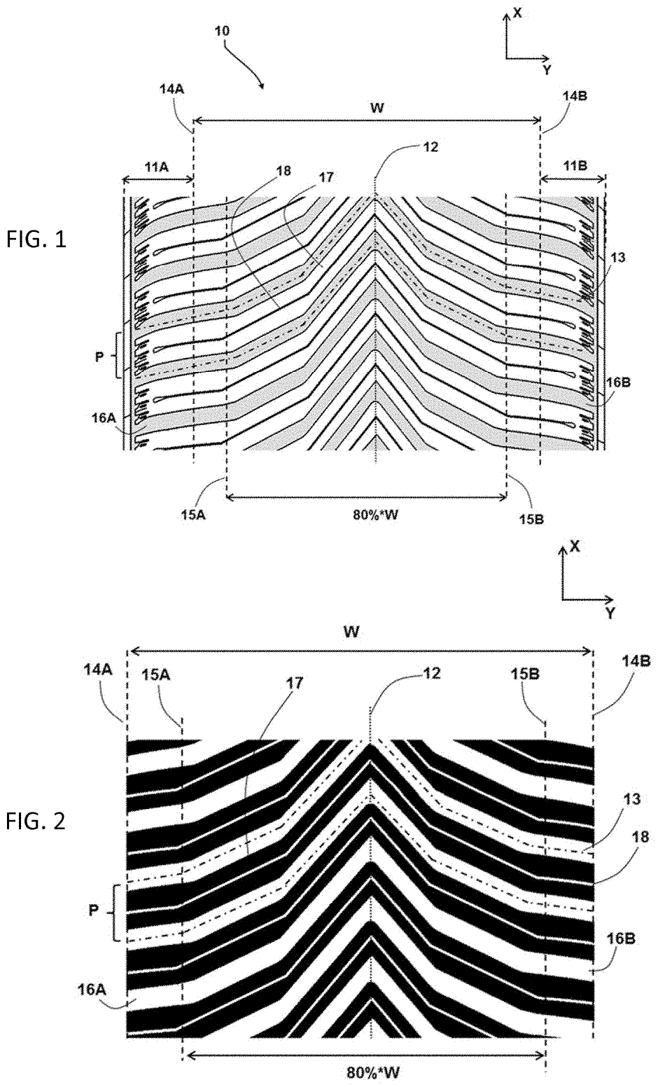

In known manner, a tyre intended to be fitted to a motor vehicle has a tread. This tread comprises a tread surface and two edges delimiting said tread surface. The tread surface corresponds to all of the points of the tread that come into contact with a road surface when the tyre, inflated to its reference pressure and compressed by a reference load, is running on this road surface. The reference inflation pressure and the reference load are defined in the use conditions of the tyre, which conditions are specified in particular by the E.T.R.T.O. standard. The tread surface of the tread comprises voids formed by various grooves, such as oblique grooves. The oblique grooves form channels intended to remove water towards the edges of the tread. Document GB2240522 discloses a directional tread comprising a plurality of oblique grooves. The tread comprises a central axis X and two edges which flank said tread and which determine a tread width, denoted A in FIG. 1. The tread also has a central part of a width denoted K and which corresponds to approximately 80% of the width A of the tread. In this central part, each oblique groove has a large slenderness ratio, which is to say that the projection, in the circumferential direction X, of said groove is very close to, or even greater than, half the width K of this central part. The very high slenderness ratio of the oblique grooves provides an improvement to the water removal from the tread, and thus provides an improvement to grip on wet ground. However, the blocks of material delimited by these oblique grooves may suffer a higher level of wear because of their lower transverse stiffness. Furthermore, behaviour on dry ground is also penalized by the high slenderness ratio of the oblique grooves. Finally, on snowy ground, this type of tyre offers limited grip.

Furthermore, there is an increasing demand for so-called “four-season” tyres which offer an excellent compromise between grip on snowy ground/wet ground while still maintaining good performance on dry ground. These four-season tyres are intended to run safely all the year round, whatever the weather. These tyres have generally received the 3PMSF (3 Peak Mountain Snow Flake) winter certification. This certification is notably indicated on one or both of the sidewalls of said tyres.

There is therefore a need to obtain a four-season tyre that offers grip performance on dry ground and on wet ground that is similar to that of a summer tyre, while at the same time ensuring a very high level of safety on snowy ground and improved wear resistance.

### SUMMARY OF THE INVENTION

The present invention aims to remedy this drawback.

More specifically, the present invention seeks to improve the compromise between grip on snowy ground/wet ground for a four-season tyre while at the same time improving the wearing performance of such a tyre.

The invention relates to a tyre comprising a directional tread.

A “tyre” means all types of tyre casing made of a rubbery material and which, during running is subjected to an internal pressure or not subjected to such an internal pressure during running (which is the case of an airless tyre, for example of the Tweel™ type).

A “rubbery material” means a diene elastomer, that is to say, in a known way, an elastomer which is based, at least partially (i.e. is a homopolymer or copolymer of), on diene monomers (monomers bearing conjugated or non-conjugated carbon-carbon double bonds).

The “tread” of a tyre means a quantity of rubbery material delimited by a tread surface. The tread surface groups together all the points of the tyre that will come into contact with the ground under normal running conditions. For a tyre, the “normal running conditions” are the use conditions defined by the ETRTO (European Tyre and Rim Technical Organisation) standard. These use conditions specify the reference inflation pressure corresponding to the load-bearing capacity of the tyre as indicated by its load index and its speed rating. These use conditions can also be referred to as “nominal conditions” or “working conditions”.

A “directional tread” means a tread in which the tread pattern elements are specifically arranged to optimize the behavioural characteristics depending on a predetermined sense of rotation. This sense of rotation is conventionally indicated by an arrow on the sidewall of the tyre.

The tread of the invention comprises a central axis and tow edges flanking said central axis and determining a tread width W, the tread width being greater than or equal to 140 mm. This tread width is determined from an impression produced dynamically. In order to obtain such an impression, black ink is spread over part of the tread of the tyre and this inked part is run over a sheet of paper at a certain speed of travel. The conditions under which such an impression is produced are that it is produced at the nominal pressure, for a load corresponding to 0.76 times the nominal load and at a speed of travel of 100 mm/s. For example, for a tyre of size 205/55R16 91V, the conditions under which the impression is produced are a pressure of 2.5 bar and a load of 480 daN. All of the measurements for determining the slenderness ratio E, the sipes density SD, the mean sipes density SDmean, are then taken from an impression of the tread, running on a support under the load, pressure and speed-of-travel conditions as described above.

The tread comprises a plurality of patterns which succeed one another in the circumferential direction, each pattern having a pitch P.

A “pattern” means a collection of blocks which is repeated in the circumferential direction. This repeat may be an “iso-dimensional” repeat. The tread is then said to be monopitch. As an alternative, this repeat may be a repeat with different dimensions, notably different pitch values. The tread is then said to be multipitch. Advantageously, the number of different pitch values for a multi-pitch tread is comprised between 3 and 5 pitches. As a preference, the set of blocks of the pattern extends across the entire tread width W. Each set of blocks comprises at least one block. A “block” means a raised element delimited by grooves and comprising lateral walls and a contact face, the latter being intended to come into contact with the ground during running.

A “circumferential direction” means a direction tangential to any circle centred on the axis of rotation. This direction is perpendicular both to an axial direction and to a radial direction.

An “axial direction” means a direction parallel to the axis of rotation of the tyre.

A “radial direction” means a direction which is perpendicular to the axis of rotation of the tyre (this direction corresponds to the direction of the thickness of the tread at the centre of said tread).

A “groove” means a cut for which the distance between the walls of material is greater than 2 mm.

An “oblique groove” means a groove of which the main orientation makes an acute angle comprised between 20° and 70° with the axial direction.

A “circumferential groove” means a groove of which the main orientation is in the circumferential direction.

A “sipe” means a cut of which the distance between the walls of material is less than or equal to 2 mm. It is also determined that the depth of a sipe in the tread is greater than or equal to 1 mm. As a result, aesthetic cuts in the tread, of the “V-groove” type, the depth of which is less than 1 mm, are not considered to be sipes.

The patterns delimit a plurality of oblique grooves, each oblique groove extending from one of the edges of the tread towards the central axis.

In a central part of the tread centred on the central axis and of a width corresponding to 80% of the width W of said tread, all or some of the oblique grooves of the plurality of oblique groove has a slenderness ratio comprised between 0.85 and 1.5 and preferably between 0.87 and 1.1. With such a value for the slenderness ratio in the central part of the tread, it is possible to ensure better removal of water from the tread, and the risks of aquaplaning are consequently limited.

A “slenderness ratio” E means the ratio between a projected length Lpx of the oblique groove in the circumferential direction and half the width W of the central part of the tread, such that

$$E = \frac{Lpx}{0.4 * W} .$$

Each pattern comprises at least one sipe. A sipes density SD in the pattern is comprised between 10 mm⁻¹ and 70 mm⁻¹.

A “sipes density SD” means the ratio between the sum of the projected length(s) lpyi of the sipe(s) in an axial direction to the product of the pitch P of the pattern and of the width W of the tread, such that

$$SD = \frac{{\sum }_{i = 1}^{n} lpyi}{P * W} * 1000 ,$$

where n is the number of sipes in the pattern.

The characteristics of the tread which have thus been listed make it possible to obtain a tyre of the four-season type offering an excellent compromise between grip on snowy ground/wet ground while at the same time improving the wearing performance of this tyre.

In one preferred embodiment, the tread comprises different pattern types Mj, where j is greater than or equal to 2, the patterns belonging to the one same pattern type having the one same pitch, the pitch between patterns belonging to two different pattern types being different, and in that the mean sipes density (SDmean) is comprised between 10 mm⁻¹ and 70 mm⁻¹, said mean sipes density (SDmean) corresponding to the mean of the sipes densities SDj of the patterns of the different pattern types Mj over the entire circumference of the tread, said mean sipes density SDmean being weighted according to the number of patterns Nj per pattern type Mj and according to the pitch Pj of the patterns belonging to that pattern type Mj over said circumference of the tread, such that

$$SDmean = \frac{{\sum }_{j = 1}^{m} ( SDj * Nj * Pj )}{{\sum }_{j = 1}^{m} ( Nj * Pj )}$$

where SDj is the sipes density in a pattern belonging to the pattern type Mj, Pj is the pitch of the patterns belonging to the pattern type Mj, and Nj is the number of patterns belonging to the pattern type Mj.

As a preference, the sipes density SD or the mean sipes density SDmean is greater than 25 mm⁻¹ and/or less than 50 mm⁻¹.

As a preference, the sipes density SD or the mean sipes density SDmean is comprised between 30 mm⁻¹ and 40 mm⁻¹.

In one preferred embodiment, each pattern comprising a set of blocks comprising at least one block, wherein said block has a maximum radial height Hmax when new that is comprised between 5.5 mm and 9 mm and preferably between 6 mm and 7.5 mm.

Reducing the radial height of the block provides an overall improvement to the rolling resistance of the tyre and the roadholding on dry ground. The high slenderness ratio of the tread makes it possible to compensate, at least in part, for a lower radial height of block as far as water removal performance is concerned.

In one preferred embodiment, each pattern comprises at least two adjacent blocks and the number of sipes in each block is greater than or equal to one sipe. The number of sipes and/or the arrangement of said sipes differs between the two adjacent blocks.

In one preferred embodiment, each block is made of a rubbery material. The composition of this rubbery material has a glass transition temperature Tg comprised between −40° C. and −10° C. and preferably between −35° C. and −15° C. The glass transition temperature Tg of the rubbery material is measured by means of a differential scanning calorimeter. The analysis is carried out according to the requirements of Standard ASTM D3418.

The composition of this rubbery material also has a shear modulus G* measured at 60° C. comprised between 0.5 MPa and 1.5 MPa, and preferably between 0.8 MPa and 1.1 MPa. The shear modulus G* characterizes the composition of the rubbery material. This mechanical property is measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz during a temperature sweep is recorded. The results made use of are the dynamic complex shear modulus G* measured at 60° C. The G* value measured at 60° C. is indicative of the stiffness of the rubbery material, namely of its resistance to elastic deformation.

As far as the chemical composition is concerned, the elastomer compound of the block or blocks contains 100 phr (parts per hundred rubber, by weight) of a modified diene elastomer. A diene elastomer is, by definition, a homopolymer or a copolymer resulting at least in part from diene monomers, i.e. from monomers bearing two carbon-carbon double bonds which may or may not be conjugated. As a preference, the elastomer compound contains the modified diene elastomer at a content at least equal to 20 phr.

The modified diene elastomer contains at least one functional group comprising a silicon atom, the latter being situated within the main chain, including the ends of the chain. An “atom situated within the main chain of the elastomer, including the ends of the chain” here means an atom that is not an atom hanging down from (or a lateral atom in) the main chain of the elastomer but is an atom that is integrated into the main chain. Thus, the composition of the at least one block preferably comprises an elastomer compound, said elastomer compound containing a modified diene elastomer containing at least one functional group comprising a silicon atom, the latter being situated within the main chain of the elastomer, including the ends of the chain.

The modified diene elastomer containing a functional group comprising a silicon atom may be a modified elastomer containing at least one silanol functional group situated at one end of the main chain of the elastomer. Corresponding modified diene elastomers are notably described in documents EP 0 778 311 A1, WO 2011/042507 A1.

Alternatively, and as a preference, the functional group is situated in the main elastomer chain and the diene elastomer can then be said to be coupled or else functionalized in the middle of the chain. The silicon atom of the functional group therefore bonds the two branches of the main chain of the diene elastomer. The silicon atom of the functional group may be substituted by at least one alkoxy functional group which may potentially have been fully or partially hydrolysed to hydroxyl.

Particularly advantageously, the modified diene elastomer is predominantly functionalized in the middle of the chain by an alkoxysilane group bonded to the two branches of the modified diene elastomer via the silicon atom.

The silicon atom of the functional group may be substituted by at least one alkoxy functional group which may potentially have been fully or partially hydrolysed to hydroxyl, the silicon atom may also be substituted, directly or via a divalent hydrocarbon radical, by at least one other functional group containing at least one heteroatom selected from N, S, O, P. As a preference, the silicon atom is substituted by at least one other functional group via a divalent hydrocarbon radical, more preferably a C₁-C₁₈ linear aliphatic one. Included amongst these other functional groups mention may, by way of example, be made of primary, secondary or tertiary amines, cyclic or non-cyclic, isocyanates, imines, cyanos, thiols, carboxylates, epoxides, and primary, secondary or tertiary phosphines. The other functional group is preferably a tertiary amine, more preferentially a diethylamino- or dimethylamino-group. The alkoxy functional group is preferably a methoxy, ethoxy, butoxy or propoxy functional group. Modified diene elastomers corresponding to these variants are notably described in documents WO 2009/133068 A1, WO 2015/018743 A1.

The modification of the diene elastomer by at least one functional group containing a silicon atom does not exclude another modification of the elastomer for example at the end of the chain by an amine functional group introduced at the time of initiation of polymerization, as described in WO 2015/018774 A1, WO 2015/018772 A1.

In particular, the modified diene elastomer containing a functional group comprising a silicon atom is advantageously a modified elastomer containing, within its structure, at least one alkoxysilane group bonded to the elastomer via the silicon atom, and at least one functional group comprising a nitrogen atom.

In that case, the modified diene elastomer advantageously exhibits at least two, and preferably all, of the following characteristics:
the functional group comprising a nitrogen atom is a tertiary amine, more particularly a diethylamino- or dimethylamino-group,
the functional group comprising a nitrogen atom is borne by the alkoxysilane group via a spacer group defined as an aliphatic C₁-C₁₀ hydrocarbon-based radical, more preferentially still the linear C₂ or C₃ hydrocarbon-based radical,
the alkoxysilane group is a methoxysilane or an ethoxysilane, optionally partially or completely hydrolysed to give silanol

Such modified diene elastomers may be obtained using the method described in patent application EP 2 285 852, followed by hydrolysis of the alkoxysilane functional group to give a silanol functional group. The hydrolysis reaction for hydrolysing the alkoxysilane functional group to give a silanol functional group may, for example, be performed in accordance with the procedure described in patent application EP 2 266 819 A1.

As a preference, the modified diene elastomer according to the invention is a 1,3-butadiene polymer, more preferably a styrene/butadiene copolymer (SBR).

Advantageously, the modified diene elastomer has a glass transition temperature comprised within a range extending from −105° C. to −70° C., preferably from −100° C. to −75° C., and preferably from −95° C. to −80° C.

The modified diene elastomer according to the invention may, according to different variants, be used alone in the elastomeric compound or as a blend with at least one other diene elastomer conventionally used in tyres, whether it is star-branched, coupled, functionalized, for example with tin or with silicon, or not.

Likewise from the viewpoint of its chemical composition, the elastomer compound of the tread according to the invention comprises a plasticizing resin of the thermoplastic resin type at a content at least equal to 10 phr, preferably from 10 to 100 phr, preferably from 20 to 50 phr.

In one nonlimiting embodiment, the tyre has a 3PMSF winter certification, said certification being indicated on a sidewall of the tyre.

The present invention will be understood better upon reading the detailed description of embodiments that are given by way of entirely non-limiting examples and are illustrated by the appended drawings, in which:

FIG. 1 is a schematic view showing part of a tread of a tyre according to a first embodiment of the invention;

FIG. 2 is an impression of the tread of FIG. 1;

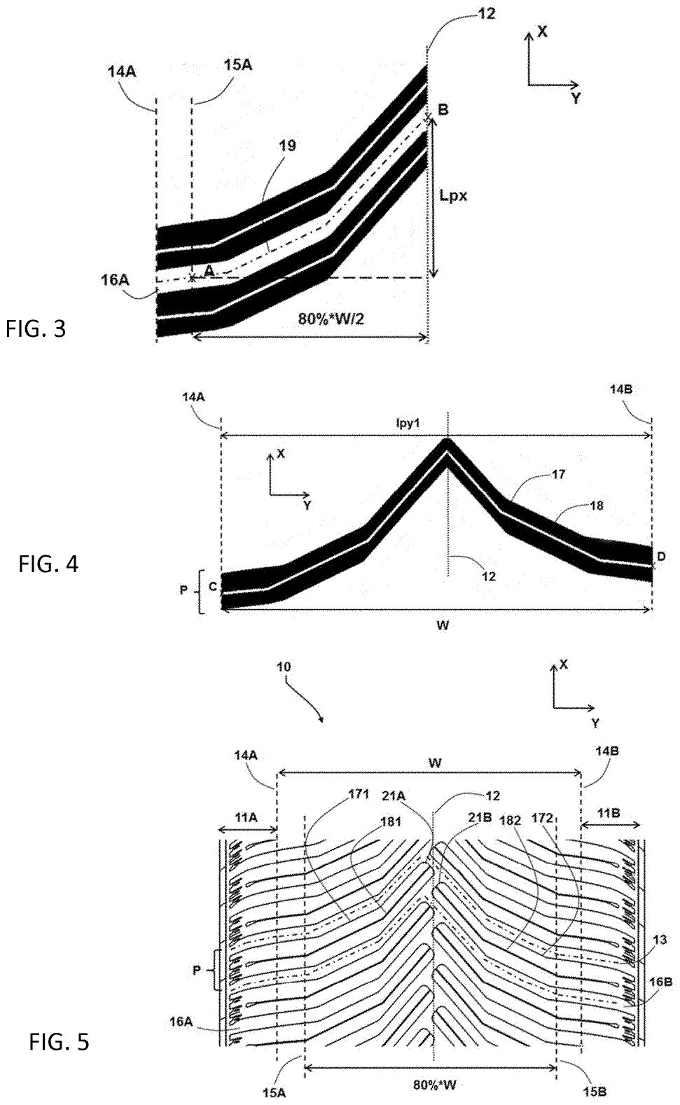

FIG. 3 is part of the impression of FIG. 2, centred on an oblique groove;

FIG. 4 is part of the impression of FIG. 2, centred on a pattern;

FIG. 5 is a schematic view showing part of a tread of a tyre according to the invention, according to a second embodiment;

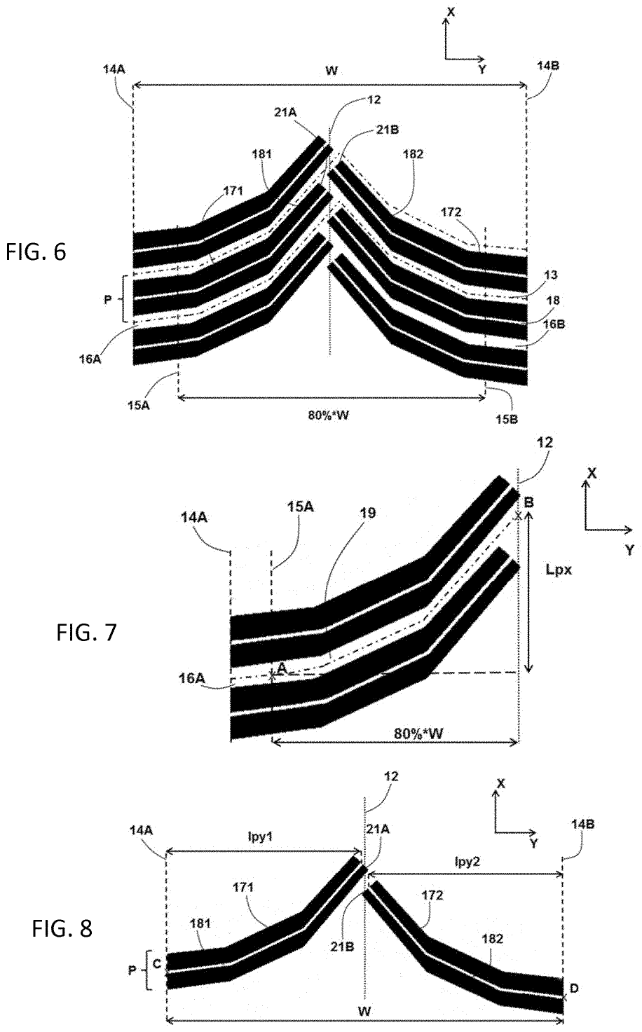

FIG. 6 is an impression of the tread of FIG. 5;

FIG. 7 is part of the impression of FIG. 6, centred on an oblique groove;

FIG. 8 is part of the impression of FIG. 6, centred on a pattern;

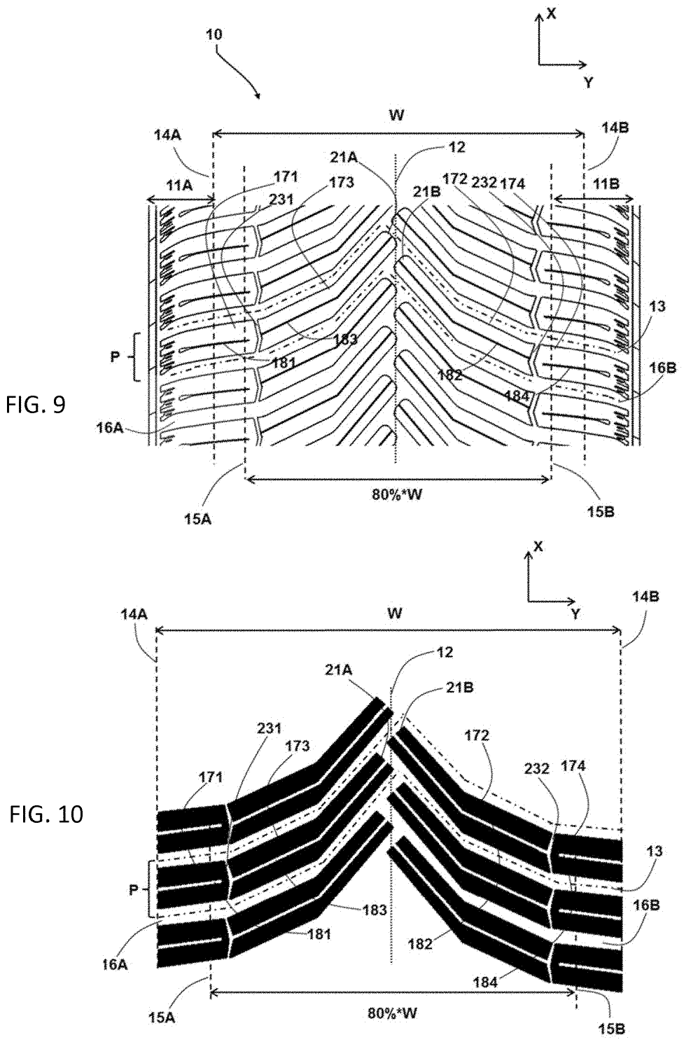

FIG. 9 is a schematic view showing part of a tread of a tyre according to the invention, according to a third embodiment of the invention;

FIG. 10 is an impression of the tread of FIG. 9;

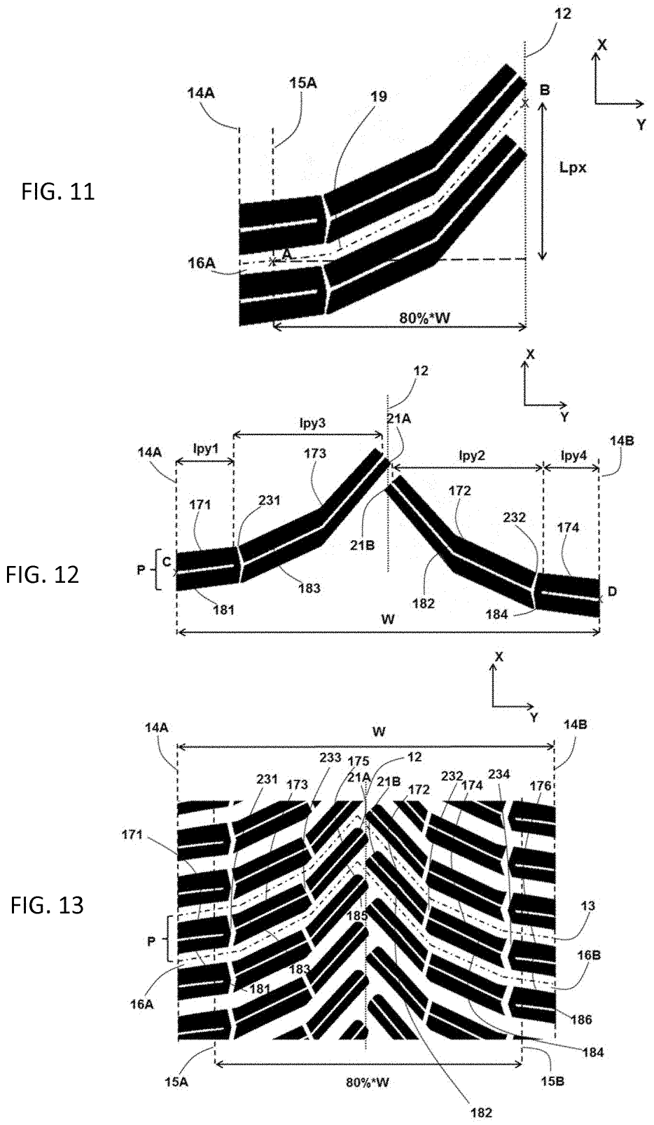

FIG. 11 is part of the impression of FIG. 10, centred on an oblique groove;

FIG. 12 is part of the impression of FIG. 10, centred on a pattern;

FIG. 13 is part of an impression of a tread of a tyre according to the invention, according to a fourth embodiment of the invention;

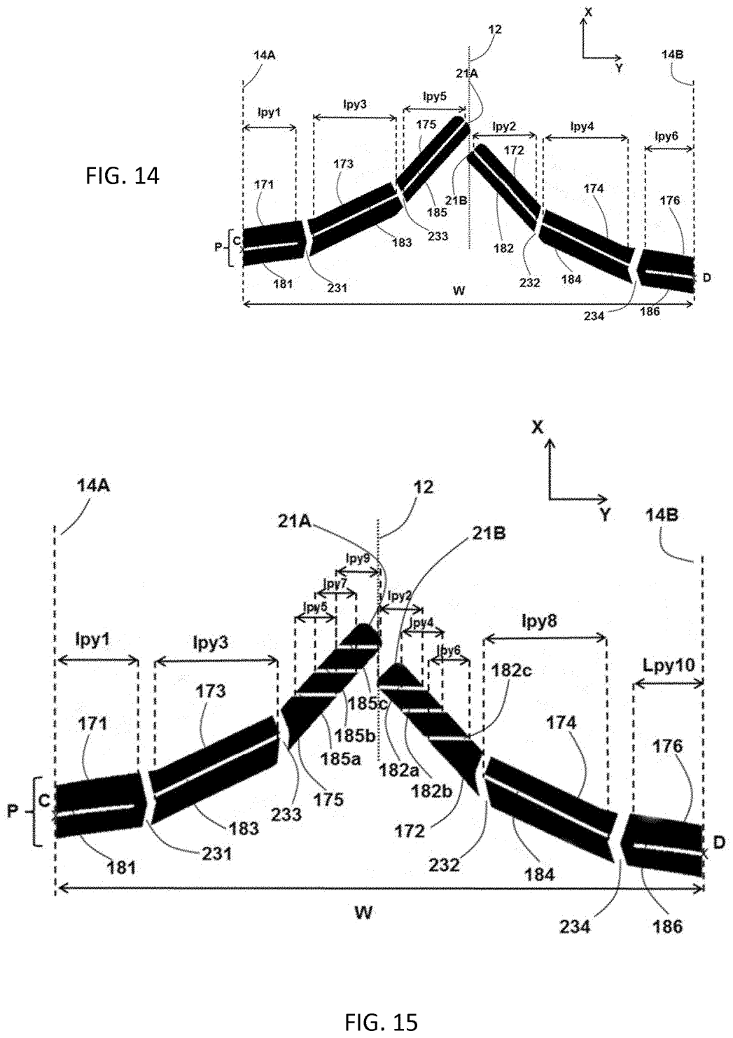

FIG. 14 is part of the impression of FIG. 13, centred on a pattern;

FIG. 15 is part of an impression of a tread of a tyre according to the invention, according to a fifth embodiment of the invention;

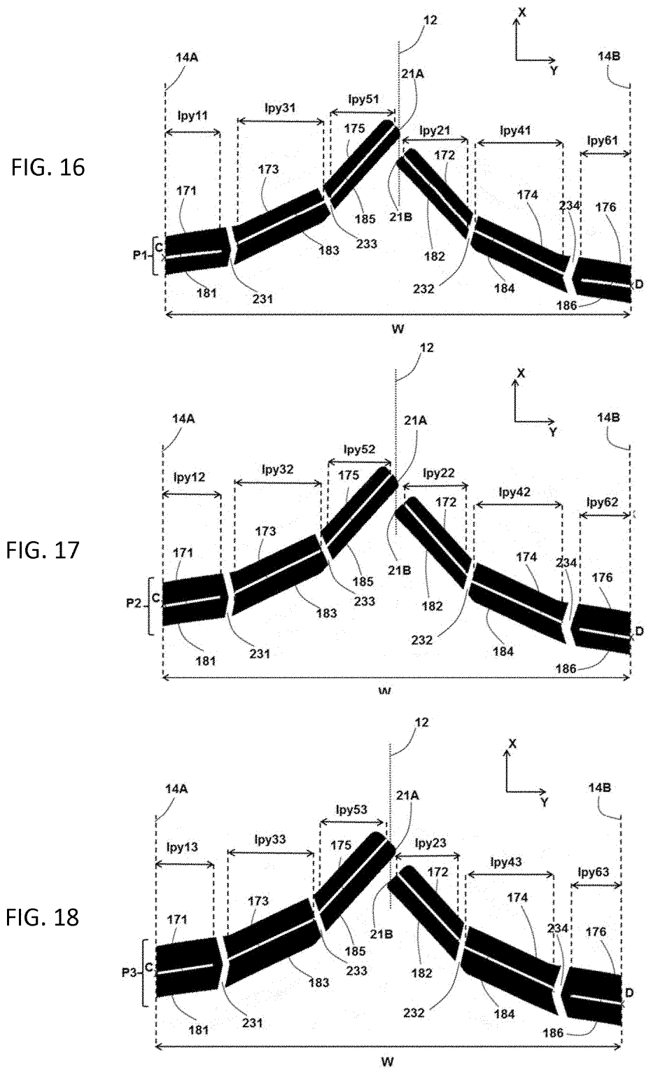

FIG. 16 is part of an impression of a multi-pitch tread of a tyre according to a sixth embodiment of the invention, said figure being centred on a first pattern of pitch P1;

FIG. 17 is part of an impression of a multi-pitch tread of a tyre according to a sixth embodiment of the invention, said figure being centred on a second pattern of pitch P2;

FIG. 18 is part of an impression of a multi-pitch tread of a tyre according to a sixth embodiment of the invention, said figure being centred on a third pattern of pitch P3.

The invention is not limited to the embodiments and variants presented and other embodiments and variants will become clearly apparent to a person skilled in the art.

In the various figures, elements that are identical or similar bear the same reference. Thus, the references used to identify elements on the tread are used together in order to identify these same elements on the impression made of said tread.

FIG. 1 partially depicts a tread according to a first embodiment of the invention. This tyre comprises a tread 10 and two sidewalls 11A, 11B flanking said tread 10. The sidewalls 11A, 11B form the lateral parts of the tyre. Each sidewall at its end comprises a bead intended to be seated on a rim of a wheel. The sidewalls 11A, 11B define the tread 10 at a first edge 14A and a second edge 14B. The first edge 14A and the second edge 14B flank a central axis 12 of the tread 10. This first edge 14A and this second edge 14B determine a tread width W. This tread width here is greater than 140 mm. The tread 10 also comprises a central part centred on the central axis 12 and the width of which corresponds to 80% of the width W of said tread 10. This central part is delimited by a third edge 15A and a fourth edge 15B. The tread 10 comprises a plurality of patterns 13 which succeed one another in the circumferential direction X. Each pattern 13 comprises a block 17 which extends, in the embodiment of FIG. 1, continuously from the first edge 14A of the tread 10 as far as the second edge 14B. This block 17 is delimited by oblique grooves 16A, 16B which are shaded grey in FIG. 1. In the tread, the oblique grooves 16A, 16B extend from the first edge 14A and from the second edge 14B as far as the central axis 12 of the tread. These oblique grooves 16 encourage the removal of water from the tread while running on a wet road surface. The block 17 also comprises a sipe 18 to improve the grip of the tyre on snowy ground. In the tread, this sipe 18 extends continuously from the first edge 14A to the second edge 14B. More specifically, the sipe 18 here divides the block 17 into two parts of roughly identical width.

Each pattern 13 has a pitch P. This pitch P is determined as being the distance between the centres of two adjacent oblique grooves flanking a block 17. It will be noted that, in the example of FIG. 1, the pitch P of the various patterns of the tread is identical.

FIG. 2 depicts an impression of the tread of FIG. 1. This impression has been made dynamically under conditions as described hereinabove. The recessed “voids” elements such as the oblique grooves 16A, 16B, and the sipes 18 are represented in white. The blocks 17 are illustrated in black. From this impression, it is possible to determine the slenderness ratio E of the oblique grooves (FIG. 3) and a sipes density SD for the sipes in the blocks 17 (FIG. 4).

FIG. 3 depicts part of the impression of FIG. 2, centred on an oblique groove 16A. In the tread, this oblique groove 16A begins from the first edge 14A and stops at the central axis 12. It is possible to determine a slenderness ratio E for the oblique groove 16A in the central part of the tread, namely the level of its inclination in this central part. As has already been specified, the central part is delimited in part by the third edge 15A. The slenderness ratio E is determined from a projected length Lpx of the oblique groove 16A in the circumferential direction X and half the width of the central part of the tread, 0.8*W/2, such that

$$E = \frac{Lpx}{0.4 * W} .$$

More particularly, the projected length Lpx is measured between a first point A and a second point B. The point A is determined at the intersection between a midline 19 of the oblique groove 16A and the third edge 15A. The midline 19 of the oblique groove 16A divides said oblique groove 16A into two oblique half-grooves of the same width. The point B is determined at the intersection between the midline 19 of the oblique groove 16A and the central axis 12 of the tread 10. The slenderness ratio E is here comprised between 0.85 and 1.5, and preferably between 0.87 and 1.1.

FIG. 4 depicts part of the impression of FIG. 2, centred on a block 17. As has already been specified, the block 17 extends continuously from the first edge 14A to the second edge 14B. The sipe 18 also extends continuously between a third point C and a fourth point D. The third point C is determined at the intersection between the sipe 18 and the first edge 14A. The fourth point D is determined at the intersection between the sipe 18 and the second edge 14B. The sipes density SD in the block 17 is comprised between 10 mm⁻¹ and 42 mm⁻¹, and preferably between 30 mm⁻¹ and 40 mm⁻¹. This sipes density SD here corresponds to the ratio between the sum of the projected length lpyi of the single sipe 18 in an axial direction Y to the product of the pitch P of the pattern and of the width W of the tread, all then multiplied by 1000, such that

$$SD = \frac{lpy 1}{P * W} *$$

1000. In the embodiment of FIG. 4, the projected length lpy1 is equal to the tread width W. Therefore

$$SD = \frac{1000}{P} .$$

Thus, for a pitch of 30 mm, the sipes density in the block 17 is 33.33 mm⁻¹.

FIG. 5 partially depicts a tyre according to a second embodiment of the invention. This tyre comprises a tread 10 and two sidewalls 11A, 11B flanking said tread 10. The sidewalls 11A, 11B form the lateral parts of the tyre. Each side wall at its end comprises a bead intended to be seated on a rim of a wheel. The sidewalls 11A, 11B define the tread 10 at a first edge 14A and a second edge 14B. The first edge 14A and the second edge 14B flank a central axis 12 of the tread 10. This first edge 14A and this second edge 14B determine a tread width W. This tread width here is greater than 140 mm. The tread 10 also comprises a central part centred on the central axis 12 and the width of which corresponds to 80% of the width W of said tread 10. This central part is delimited by a third edge 15A and a fourth edge 15B. The tread 10 comprises a plurality of patterns 13 which succeed one another in the circumferential direction X. Each pattern 13 comprises a set of blocks here comprising a first block 171 and a second block 172. These blocks 171, 172 extend respectively from the first edge 14A and from the second edge 14B of the tread 10, as far as the central axis 12. These blocks 171, 172 are delimited by oblique grooves 16A, 16B. In the tread of FIG. 5, the oblique grooves 16A, 16B extend respectively from the first edge 14A and from the second edge 14B as far as the central axis 12. These oblique grooves 16A, 16B encourage the removal of water from the tread when running on a wet road surface. Each block 171, 172 respectively comprises a first sipe 181 and a second sipe 182 to improve the grip of the tyre on snowy ground. In the impression of the tread of FIG. 5, each sipe 181, 182 extends respectively continuously from the first edge 14A or from the second edge 14B as far as one end 21A, 21B of the block 171, 172.

More specifically, each sipe 181, 182 divides the associated block 171, 172 into two parts of roughly identical width.

Each pattern 13 has a pitch P. This pitch P is determined as being the distance between the centres of two adjacent oblique grooves flanking a block 171, 172. It will be noted that, in the example of FIG. 5, the pitch P of the various patterns of the tread is identical.

FIG. 6 depicts an impression of the tread of FIG. 5. This impression has been made dynamically under conditions as described hereinabove. The recessed “voids” elements such as the oblique grooves 16A, 16B, and the sipes 181, 182 are represented in white. The blocks 171, 172 are illustrated in black. From this impression, it is possible to determine a slenderness ratio E of the oblique grooves (FIG. 7) and a sipes density SD for the sipes in the blocks 171, 172 (FIG. 8).

FIG. 7 depicts part of the impression of FIG. 6, centred on an oblique groove 16A. In the tread, this oblique groove 16A begins from the first edge 14A and stops at the central axis 12. It is possible to determine a slenderness ratio E for the oblique groove 16A in the central part of the tread, namely the level of its inclination in this central part. As has already been specified, the central part is delimited in part by the third edge 15A. The slenderness ratio E is determined from a projected length Lpx of the oblique groove 16A in the circumferential direction X and half the width of the central part of the tread, 0.8*W/2, such that

$$E = \frac{L p x}{0.4 * W} .$$

More particularly, the projected length Lpx is measured between a first point A and a second point B. The point A is determined at the intersection between a midline 19 of the oblique groove 16A and the third edge 15A. The midline 19 of the oblique groove 16A divides said oblique groove 16A into two oblique half-grooves of the same width. The point B is determined at the intersection between the midline 19 of the oblique groove 16 and the central axis 12 of the tread 10. The slenderness ratio E is here comprised between 0.85 and 1.5, and preferably between 0.87 and 1.1.

FIG. 8 depicts part of the impression of FIG. 6, centred on the first block 171 and the second block 172. As has already been specified, the first block 171 extends from the first edge 14A as far as the central axis 12 of the tread and the second block 172 extends from the second edge 14B as far as the central axis 12 of the tread. The first sipe 181 of the first block 171 extends continuously between a third point C and the end 21A of the block 171. The third point C is determined at the intersection between the first sipe 181 and the first edge 14A. The second sipe 182 of the second block 172 extends continuously between a fourth point D and the end 21B of the block 172. The fourth point D is determined at the intersection between the second sipe 182 and the second edge 14B. The sipes density SD in the set of blocks comprising the first block 171 and the second block 172 is comprised between 10 mm⁻¹ and 42 mm⁻¹, and preferably between 30 mm⁻¹ and 40 mm⁻¹. This sipes density SD corresponds to the ratio between the projected length lpy1 and lpy2 of the first sipe 181 and of the second sipe 182 in an axial direction Y to the product of the pitch P of the pattern and of the width W of the tread, all then multiplied by 1000, such that

$$SD = \frac{l p y 1 + l p y 2}{P * W} * 1000 .$$

FIG. 9 partially depicts a tyre according to a third embodiment of the invention. This tyre comprises a tread 10 and two sidewalls 11A, 11B flanking said tread 10. The sidewalls 11A, 11B define the tread 10 at a first edge 14A and a second edge 14B. The first edge 14A and the second edge 14B flank a central axis 12 of the tread 10. This first edge 14A and this second edge 14B determine a tread width W. This tread width here is greater than 140 mm. The tread 10 also comprises a central part centred on the central axis 12 and the width of which corresponds to 80% of the width W of said tread 10. This central part is delimited by a third edge 15A and a fourth edge 15B. The tread 10 comprises a plurality of patterns 13 which succeed one another in the circumferential direction X. Each pattern 13 comprises a set of blocks here comprising 4 blocks, these being a first block 171, a second block 172, a third block 173 and a fourth block 174. The first block 171 and the third block 173 are situated on the same side of the central axis 12. Likewise, the second block 172 and the fourth block 174 are situated on the same side of the central axis 12 in opposition with respect to the first block 171 and to the third block 173. The first block 171 and the third block 173 are separated by a first cut 231. The second block 172 and the fourth block 174 are separated by a second cut 232. The first cut 231 and the second cut 232 here are grooves which disconnect the blocks from one another to make it easier for the tread to flatten out during running. As a variant, in instances in which the first cut 231 is a sipe, the two blocks 171, 173 are considered to form just one single block. Likewise, in instances in which the second cut 232 is a sipe, the two blocks 172, 174 are considered to form just one single block. Thus, the first block 171 and the fourth block 174 extend respectively from the first edge 14A and from the second edge 14B of the tread 10, as far as the first cut 231 and the second cut 232. The second block 172 and the fourth block 174 extend respectively from the first cut 231 and from the second cut 232, as far as the central axis 12. The blocks 171, 172, 173, 174 are delimited by oblique grooves 16A, 16B. In the tread of FIG. 5, the oblique grooves 16A, 16B extend respectively from the first edge 14A and from the second edge 14B as far as the central axis 12. These oblique grooves 16A, 16B encourage the removal of water from the tread when running on a wet road surface. Each block 171, 172, 173, 174 respectively comprises a first sipe 181, a second sipe 182, a third sipe 183 and a fourth sipe 184 to improve the grip of the tyre on snowy ground. In the impression of the tread of FIG. 9, the first sipe 181 and the fourth sipe 184 extend respectively from the first edge 14A or from the second edge 14B as far as one end which in this case does not open onto the first cut 231 or the second cut 232. The second sipe 182 and the third sipe 183 extend respectively from the second cut 232 and from the first cut 231 as far as the end 21B of the block 172, or as far as the end 21A of the block 173. Each sipe 181, 182, 183, 184 divides the associated blocks 171, 172, 173, 174 into two half-blocks of roughly identical width.

Each pattern 13 has a pitch P. This pitch P is determined as being the distance between the centres of two adjacent oblique grooves flanking a block 171, 172, 173, 174. It will be noted that, in the example of FIG. 9, the pitch P of the various patterns of the tread is identical.

FIG. 10 depicts an impression of the tread of FIG. 9. This impression has been made dynamically under conditions as described hereinabove. The recessed “voids” elements such as the oblique grooves 16A, 16B, and the sipes 181, 182, 183, 184 are represented in white. The blocks 171, 172, 173, 174 are illustrated in black. From this impression, it is possible to determine a slenderness ratio E of the oblique grooves (FIG. 11) and a sipes density SD for the sipes in the blocks 171, 172, 173, 174 (FIG. 12).

FIG. 11 depicts part of the impression of FIG. 10, centred on an oblique groove 16A. In the tread, this oblique groove 16A begins from the first edge 14A and stops at the central axis 12. It is possible to determine a slenderness ratio E for the oblique groove 16A in the central part of the tread, namely the level of its inclination in this central part. As has already been specified, the central part is delimited in part by the third edge 15A. The slenderness ratio E is determined from a projected length Lpx of the oblique groove 16A in the circumferential direction X and half the width of the central part of the tread, 0.8*W/2, such that

$$E = \frac{L p x}{0.4 * W} .$$

More particularly, the projected length Lpx is measured between a first point A and a second point B. The point A is determined at the intersection between a midline 19 of the oblique groove 16A and the third edge 15A. The midline 19 of the oblique groove 16A divides said oblique groove 16A into two oblique half-grooves of the same width. The point B is determined at the intersection between the midline 19 of the oblique groove 16 and the central axis 12 of the tread 10. The slenderness ratio E is here comprised between 0.85 and 1.5, and preferably between 0.87 and 1.1.

FIG. 12 depicts part of the impression of FIG. 10, centred on the first block 171, the second block 172, the third block 173 and the fourth block 174. As has already been specified, the block 171 extends from the first edge 14A as far as the first cut 231. The third block 173 extends from the first cut 231 as far as the end 21A of the block 173. The second block 172 extends from the end 21B of the block 172 as far as the second cut 232. The fourth block extends from the second cut 232 as far as the second edge 14B. The first sipe 181 of the first block 171 extends between a third point C and an end close to the first cut 231. The third point C is determined at the intersection between the first sipe 181 and the first edge 14A. The third sipe 183 extends from the first cut 231 as far as the end 21A of the block 173. The second sipe 182 extends from the end 21B of the block 172 as far as the second cut 232. The fourth sipe 184 extends from the second cut 232 as far as the fourth point D. The fourth point D is determined at the intersection between the fourth sipe 184 and the second edge 14B. The sipes density SD in the set of blocks comprising the first block 171, the second block 172, the third block 173 and the fourth block 174 is comprised between 10 mm⁻¹ and 42 mm⁻¹, and preferably between 30 mm⁻¹ and 40 mm⁻¹. This sipes density SD corresponds to the ratio between the projected length lpy1, lpy2, lpy3 and lpy4 of the first sipe 181, of the second sipe 182, of the third sipe 183 and of the fourth sipe 184 in an axial direction Y to the product of the pitch P of the pattern and of the width W of the tread, all then multiplied by 1000, such that

$$SD = \frac{( lpy 1 + lpy 2 + lpy 3 + lpy 4 )}{P * W} * 1000 .$$

FIG. 13 partially depicts a tyre according to a fourth embodiment of the invention. As in the other embodiments described hereinabove, this tyre comprises a tread 10 and two sidewalls 11A, 11B flanking said tread 10. The sidewalls 11A, 11B define the tread 10 at a first edge 14A and a second edge 14B. The first edge 14A and the second edge 14B flank a central axis 12 of the tread 10. This first edge 14A and this second edge 14B thus determine a tread width W. This tread width here is greater than 140 mm. The tread 10 also comprises a central part centred on the central axis 12 and the width of which corresponds to 80% of the width W of said tread 10. This central part is delimited by a third edge 15A and a fourth edge 15B. The tread 10 comprises a plurality of patterns 13 which succeed one another in the circumferential direction X. Each pattern 13 comprises a set of blocks here comprising 6 blocks, these being a first block 171, a second block 172, a third block 173, a fourth block 174, a fifth block 175, and a sixth block 176. The first block 171, the third block 173 and the fifth block 175 are situated on the same side of the central axis 12. Likewise, the second block 172, the fourth block 174 and the sixth block 176 are situated on the same side of the central axis 12 in opposition with respect to the first block 171, the third block 173 and the fifth block 175. The first block 171 and the third block 173 are separated by a first cut 231. The second block 172 and the fourth block 174 are separated by a second cut 232. The third block 173 and the fifth block 175 are separated by a third cut 233. The fourth block 174 and the sixth block 176 are separated by a fourth cut 234. The first cut 231, the second cut 232, the third cut 233 and the fourth cut 234 here are grooves which disconnect the blocks from one another to make it easier for the tread to flatten out during running. In a variant, the first cut 231, the second cut 232, the third cut 233 and the fourth cut 234 are grooves. Thus, the first block 171 and the sixth block 176 extend respectively from the first edge 14A and from the second edge 14B of the tread 10, as far as the first cut 231 and the fourth cut 234. The third block 173 and the fourth block 174 extend respectively from the first cut 231 and from the fourth cut 234, as far as the third cut 233 and the second cut 232. The fifth block 175 and the second block 172 extend respectively from the third cut 233 and from the second cut 232, as far as the central axis 12. The blocks 171, 172, 173, 174, 175, 176 are delimited by oblique grooves 16A, 16B. In the tread of FIG. 13, the oblique grooves 16A, 16B extend respectively from the first edge 14A and from the second edge 14B as far as the central axis 12. As has already been indicated, these oblique grooves 16A, 16B encourage the removal of water from the tread when running on a wet road surface. Each block 171, 172, 173, 174, 175, 176 respectively comprises a first sipe 181, a second sipe 182, a third sipe 183, a fourth sipe 184, a fifth sipe 185 and a sixth sipe 186 to improve the grip of the tyre on snowy ground. In the tread-impression part of FIG. 14, the first sipe 181 and the sixth sipe 186 extend respectively from the first edge 14A or from the second edge 14B as far as one end which in this case does not open onto the first cut 231 or the fourth cut 234. The third sipe 183 and the fourth sipe 184 extend respectively from the first cut 231 and from the fourth cut 234, as far as the third cut 233 and as far as the second cut 232. The fifth sipe 185 and the second sipe 182 extend respectively from the third cut 233 and from the second cut 232 as far as the end 21A of the block 175, and as far as the end 21B of the block 172. Each sipe 181, 182, 183, 184, 185, 186 divides the associated blocks 171, 172, 173, 174, 175, 176 into two half-blocks of roughly identical width.

Each pattern 13 has a pitch P. This pitch P is determined as being the distance between the centres of two adjacent oblique grooves flanking a block 171, 172, 173, 174, 175, 176. It will be noted that, in the example of FIG. 13, the pitch P of the various patterns of the tread is identical.

As has already been specified, FIG. 14 depicts part of an impression of the tread of FIG. 13. This impression has been made dynamically under conditions as described hereinabove. The recessed “voids” elements such as the oblique grooves 16A, 16B, and the sipes 181, 182, 183, 184, 185, 186 are represented in white. The blocks 171, 172, 173, 174, 175, 176 are illustrated in black. From an impression, it is possible to determine a slenderness ratio E of the oblique grooves and a sipes density SD for the sipes in the blocks 171, 172, 173, 174, 175, 176.

The slenderness ratio E is determined in the same way as in the examples of FIGS. 8, 12. This slenderness ratio E is comprised between 0.85 and 1.5, and preferably between 0.87 and 1.1.

FIG. 14 thus depicts part of the impression of the tread of FIG. 13, centred on the first block 171, the second block 172, the third block 173, the fourth block 174, the fifth block 175 and the sixth block 176. As has already been specified, the first block 171 extends from the first edge 14A as far as the first cut 231. The third block 173 extends from the first cut 231 as far as the third cut 233. The fifth block 175 extends from the third cut 233 as far as the central axis 12. The second block 172 extends from the central axis 12 as far as the second cut 232. The fourth block 174 extends from the second cut as far as the fourth cut 234. The sixth block 176 extends from the fourth cut 234 as far as the second edge 14B. The first sipe 181 of the first block 171 extends between a third point C and an end close to the first cut 231. The third point C is determined at the intersection between the first sipe 181 and the first edge 14A. The third sipe 183 extends from the first cut 231 as far as the third cut 233. The fifth sipe 185 extends from the third cut 233 as far as the end 21A of the block 175. The second sipe 182 extends from the end 21B of the second block 172 as far as the second cut 232. The fourth sipe 184 extends from the second cut 232 as far as the fourth cut 234. The sixth sipe 176 extends from one end of this sipe close to the fourth cut 234 as far as the fourth point D. The fourth point D is determined at the intersection between the sixth sipe 186 and the second edge 14B. The sipes density SD in the set of blocks comprising the first block 171, the second block 172, the third block 173, the fourth block 174, the fifth block 175 and the sixth block 176 is comprised between 10 mm⁻¹ and 42 mm⁻¹, and preferably between 30 mm⁻¹ and 40 mm⁻¹. This sipes density SD corresponds to the ratio between the projected length lpy1, lpy2, lpy3, lpy4, lpy5, and lpy6 of the first sipe 181, of the second sipe 182, of the third sipe 183, of the fourth sipe 184, of the fifth sipe 185 and of the sixth sipe 186 in an axial direction Y to the product of the pitch P of the pattern and of the width W of the tread, all then multiplied by 1000, such that

$$SD = \frac{( lpy 1 + lpy 2 + lpy 3 + lpy 4 + lpy 5 + lpy 6 )}{P * W} * 1000 .$$

FIG. 15 depicts part of an impression of a tread according to a fifth embodiment of the invention. This part of an impression is centred on the blocks of a pattern of this tread. More specifically, this part of an impression comprises, as in the preceding embodiment, a first block 171, a second block 172, a third block 173, a fourth block 174, a fifth block 175 and a sixth block 176. The first block 171 extends from the first edge 14A as far as a first cut 231. The third block 173 extends from the first cut 231 as far as the third cut 233. The fifth block 175 extends from the third cut 233 as far as the central axis 12. The second block 172 extends from the central axis 12 as far as the second cut 232. The fourth block 174 extends from the second cut as far as the fourth cut 234. The sixth block 176 extends from the fourth cut 234 as far as the second edge 14B. The various blocks 171, 172, 173, 174, 175, 176 comprise at least one sipe. Thus, the first block 171 comprises a first sipe 181, the third block 173 comprises a third sipe 183. The fifth block 175 for its part comprises three sipes: a first fifth sipe 185a, a second fifth sipe 185b and a third fifth sipe 185c. Likewise, the second block 172 comprises three sipes: a first second sipe 182a, a second second sipe 182b and a third second sipe 182c. The fourth block 174 comprises a fourth sipe 184, and the sixth block 176 comprises a sixth sipe 186. More particularly, the first sipe 181 of the first block 171 extends between a third point C and an end close to the first cut 231. The third point C is determined at the intersection between the first sipe 181 and the first edge 14A. The third sipe 183 extends from the first cut 231 as far as the third cut 233. The first fifth sipe 185a, the second fifth sipe 185b and the third fifth sipe 185c extend roughly in the axial direction from a first lateral wall of the fifth block 175 as far as a second lateral wall of this fifth block 175. Likewise, the first second sipe 182a, the second second sipe 182b and the third second sipe 182c extend roughly in the axial direction from a first lateral wall of the second block 172 as far as a second lateral wall of this second block 172. The fourth sipe 184 extends from the second cut 232 as far as the fourth cut 234. The sixth sipe 186 extends from one end of this sipe close to the fourth cut 234 as far as a fourth point D. The fourth point D is determined at the intersection between the sixth sipe 186 and the second edge 14B. The sipes 181, 183, 184, 186 divide their associated block 171, 173, 174, 176 into two half-blocks of roughly identical width. The part of the impression of the tread that is illustrated in FIG. 15 thus comprises at least two adjacent blocks, such as the pair of blocks comprising the third block 173 and the fifth block 175 or the pair of blocks comprising the second block 172 and the fourth block 174. These adjacent blocks have different numbers of sipes and also a different arrangement of sipes. The sipes density SD in the set of blocks comprising the first block 171, the second block 172, the third block 173, the fourth block 174, the fifth block 175 and the sixth block 176 is comprised between 10 mm⁻¹ and 42 mm⁻¹, and preferably between 30 mm⁻¹ and 40 mm⁻¹. This sipes density SD corresponds to the ratio between the projected length lpy1, lpy2, lpy3, lpy4, lpy5, lpy6, lpy7, lpy8, and lpy9 of the first sipe 181, of the first second sipe 182a, of the second second sipe 182b, of the third second sipe 182c, of the third sipe 183, of the fourth sipe 184, of the first fifth sipe 185a, of the second fifth sipe 185b, of the third fifth sipe 185c and of the sixth sipe 186 in an axial direction Y to the product of the pitch P of the pattern and of the width W of the tread, all then multiplied by 1000, such that

$$SD = \frac{( \begin{matrix}lpy 1 + lpy 2 + lpy 3 + lpy 4 + lpy 5 + lpy 6 + \\ lpy 7 + lpy 8 + lpy 9 + lpy 10\end{matrix} )}{P * W} * 1000 .$$

FIGS. 16, 17 and 18 illustrate three patterns of the one same tread, belonging to three different pattern types. FIG. 16 thus illustrates a first pattern having a first pitch P1. This first pattern comprises a first block 171, a second bloc 172, a third block 173, a fourth block 174, a fifth block 175 and a sixth block 176. The first block 171 extends from the first edge 14A as far as a first cut 231. The third block 173 extends from the first cut 231 as far as the third cut 233. The fifth block 175 extends from the third cut 233 as far as the central axis 12. The second block 172 extends from the central axis 12 as far as the second cut 232. The fourth block 174 extends from the second cut 232 as far as the fourth cut 234. The sixth block 176 extends from the fourth cut 234 as far as the second edge 14B. The various blocks 171, 172, 173, 174, 175, 176 each comprise one sipe. Thus, the first block 171 comprises a first sipe 181 which extends between a third point C and an end close to the first cut 231. The third point C is determined at the intersection between the first sipe 181 and the first edge 14A. The third block 173 comprises a third sipe 183 which extends between the first cut 231 and the third cut 233. The fifth block 175 comprises a fifth sipe 185 which extends between the third cut 233 and one end 21A of the fifth block 175. The second block 172 comprises a second sipe 182 which extends between one end 21B of the second block 172 and a second cut 232. The fourth block 174 comprises a fourth sipe 184 which extends between the second cut 232 and the fourth cut 234. The sixth block 176 comprises a sixth sipe 186 which extends between the fourth cut 234 and a fourth point D. The fourth point D is determined at the intersection between the sixth sipe 186 and the second edge 14B. The sipes 181, 182, 183, 184, 185, 186 divide their associated block 171, 172, 173, 174, 175, 176 into two half-blocks of roughly identical width. This sipes density SD1 in the set of blocks of pitch P1 comprising the first block 171, the second bloc 172, the third block 173, the fourth block 174, the fifth block 175 and the sixth block 176 corresponds to the ratio between the projected length lpy11, lpy21, lpy31, lpy41, lpy51, and lpy61 of the first sipe 181, of the second sipe 182, of the third sipe 183, of the fourth sipe 184, of the fifth sipe 185 and of the sixth sipe 186 in an axial direction Y to the product of the pitch P1 of the pattern and of the width W of the tread, all then multiplied by 1000, such that

$$SD 1 = \frac{( lpy 11 + lpy 21 + lpy 31 + lpy 41 + lpy 51 + lpy 61 )}{P 1 * W} * 1000 .$$

FIG. 17 illustrates a second pattern having a second pitch P2. As was the case with the first pattern, this second pattern comprises a first block 171, a second block 172, a third block 173, a fourth block 174, a fifth block 175 and a sixth block 176. The various blocks 171, 172, 173, 174, 175, 176 each comprise one sipe 181, 182, 183, 184, 185, 186. For a more detailed description of the arrangement of the blocks 171, 172, 173, 174, 175, 176 and of the sipes 181, 182, 183, 184, 185, 186, reference may be made to the above description of the first pattern. This sipes density SD2 in the set of blocks of pitch P2 comprising the first block 171, the second bloc 172, the third block 173, the fourth block 174, the fifth block 175 and the sixth block 176 corresponds to the ratio between the projected length lpy12, lpy22, lpy32, lpy42, lpy52, and lpy62 of the first sipe 181, of the second sipe 182, of the third sipe 183, of the fourth sipe 184, of the fifth sipe 185 and of the sixth sipe 186 in an axial direction Y to the product of the pitch P2 of the pattern and of the width W of the tread, all then multiplied by 1000, such that

$$SD 2 = \frac{( lpy 12 + lpy 22 + lpy 32 + lpy 42 + lpy 52 + lpy 62 )}{P 2 * W} * 1000 .$$

FIG. 18 illustrates a third pattern having a third pitch P3. As was the case with the first pattern and the second pattern, this third pattern comprises a first block 171, a second block 172, a third block 173, a fourth block 174, a fifth block 175 and a sixth block 176. The various blocks 171, 172, 173, 174, 175, 176 each comprise one sipe 181, 182, 183, 184, 185, 186. For a more detailed description of the arrangement of the blocks 171, 172, 173, 174, 175, 176 and of the sipes 181, 182, 183, 184, 185, 186, reference may be made to the above description of the first pattern or of the second pattern. This sipes density SD3 in the set of blocks of pitch P3 comprising the first block 171, the second bloc 172, the third block 173, the fourth block 174, the fifth block 175 and the sixth block 176 corresponds to the ratio between the projected length lpy13, lpy23, lpy33, lpy43, lpy53, and lpy63 of the first sipe 181, of the second sipe 182, of the third sipe 183, of the fourth sipe 184, of the fifth sipe 185 and of the sixth sipe 186 in an axial direction Y to the product of the pitch P3 of the pattern and of the width W of the tread, all then multiplied by 1000, such that

$$SD 2 = \frac{( lpy 13 + lpy 23 + lpy 33 + lpy 43 + lpy 53 + lpy 63 )}{P 3 * W} * 1000 .$$

The tread comprises an arrangement of N1 patterns of pitch P1, N2 patterns of pitch P2, and N3 patterns of pitch P3. It is thus possible to determine a mean sipes density SDmean corresponding to the mean of the sipes densities SD1, SD2, SD3 of the patterns of pitch P1, P2, P3 over the entire circumference of the tread. The mean sipes density SDmean is thus weighted according to the number of patterns N1, N2, N3 per pattern type and the pitch P1, P2, P3, such that:

$$SD mean = \frac{( S D 1 * N 1 * P 1 + S D 2 * N 2 * P 2 + S D 3 * N 3 * P 3 )}{N 1 * P 1 + N 2 * P 2 + N 3 * P 3} .$$

The patterns of pitch P1, P2, P3 are arranged randomly on the tread so as to limit the emergence of tyre noise during running. Thus, for a tyre of size 205/55 R 16, patterns of pitch P1, P2 and P3 may be arranged relative to one another as follows: P1 P1 P2 P1 P2 P2 P2 P2 P1 P1 P2 P1 P1 P1 P2 P2 P3 P2 P2 P3 P2 P1 P2 P2 P1 P1 P1 P1 P2 P1 P2 P1 P1 P1 P1 P2 P1 P1 P2 P2 P3 P3 P3 P2 P2 P3 P3 P3 P3 P3 P2 P2 P1 P2 P2 P3 P2 P1 P2 P2 P1 P2 P3 P2 P2 P1 P2 P2 P2 P1 P1 P1 P2 P3 P2 P1. Such an arrangement would then comprise 21 patterns of pitch P1, 35 patterns of pitch P2 and 13 patterns of pitch P3. As has already been specified, a pitch P is determined as being the distance between the centres of two adjacent oblique grooves flanking a block. In order to determine, with precision, the values for the pitches P1, P2 and P3, these are measured in groups of patterns belonging to the same pattern type, for example in P1 P1 P1, P2 P2 P2 and P3 P3 P3 pattern groups.

For all the embodiments illustrated in FIGS. 1 to 18, each block is formed from a rubbery material. In one preferred embodiment, the composition of this rubbery material exhibits a glass transition temperature Tg comprised between −40° C. and −10° C. and preferably between −35° C. and −15° C. and a shear modulus measured at 60° C. comprised between 0.5 MPa and 2 MPa, and preferably between 0.7 MPa and 1.5 MPa.

In one preferred embodiment, the composition of the rubbery material of the blocks is based on at least:
an elastomer matrix comprising more than 50% by weight of a solution SBR bearing a silanol functional group and an amine functional group;
20 to 200 phr of at least one silica;
a coupling agent for coupling the silica to the solution SBR;
10 to 100 phr of a hydrocarbon-based resin having a Tg of greater than 20° C.;
15 to 50 phr of a liquid plasticizer.

The solution SBR in this preferred embodiment is a copolymer of butadiene and styrene, prepared in solution. The characteristic feature thereof is that it bears a silanol functional group and an amine functional group. The silanol functional group of the solution SBR bearing a silanol functional group and an amine functional group may for example be prepared by hydrosilylation of the elastomer chain by a silane bearing an alkoxysilane group, followed by hydrolysis of the alkoxysilane functional group to give a silanol functional group. The silanol functional group of the solution SBR bearing a silanol functional group and an amine functional group may equally be introduced by reaction of the living elastomer chains with a cyclic polysiloxane compound as described in EP 0 778 311. The amine functional group of the solution SBR bearing a silanol functional group and an amine functional group may for example be introduced by initiating polymerization using an initiator bearing such a functional group. A solution SBR bearing a silanol functional group and an amine functional group may equally be prepared by reacting the living elastomer chains with a compound bearing an alkoxysilane functional group and an amine functional group according to the procedure described in patent application EP 2 285 852, followed by hydrolysis of the alkoxysilane functional group to give a silanol functional group. According to this preparation procedure, the silanol functional group and the amine functional group are preferably situated within the chain of the solution SBR, not including the ends of the chain. The reaction producing the hydrolysis of the alkoxysilane functional group borne by the solution SBR to give a silanol functional group may be carried out according to the procedure described in patent application EP 2 266 819 A1 or else by a step of stripping the solution containing the solution SBR. The amine functional group can be a primary, secondary or tertiary amine functional group, preferably a tertiary functional group. It will also be noted that the blocks have a relatively low maximum radial height Hmax when new. This radial height is comprised between 5.5 mm and 9 mm, and preferably between 6 mm and 7.5 mm. This relatively low radial height could compromise grip on wet ground. Thus, by virtue of the invention, the radial height is compensated for by the high slenderness ratio of the tread and by the characteristics of the material used containing the solution SBR. That allows the tyre to maintain good grip on wet ground over time.

The invention is not limited to the embodiments and variants presented and other embodiments and variants will become clearly apparent to a person skilled in the art.

Thus, FIGS. 9 to 16 depict, near the first edge 14A and the second edge 14B, blind sipes that do not extend over the entire length of a block and which therefore do not join up with a cut for all the ends of the cuts. As a variant, all the sipes of the blocks of the pattern open into a cut. In another embodiment variant, all the sipes of the blocks of the pattern are blind.

Thus, FIG. 18 shows a number of oblique cuts 231, 232, 233, 234 of which the number is equal to four. In a variant, the number of oblique cuts in the tread is greater than four.

Thus, the oblique cuts 231, 232, 233, 234 have a depth identical to that of the oblique grooves 16A, 16B. As a variant, the oblique cuts have a depth smaller than that of the oblique grooves 16A, 16B.

Thus, in FIGS. 1 to 18, the patterns have a fairly simple arrangement of the block or blocks. As a variant, the patterns may exhibit more complex arrangements. For example, each pattern may comprise several adjacent blocks succeeding one another in the circumferential direction. These adjacent blocks are delimited by secondary oblique grooves. These secondary oblique grooves may exhibit an identical slenderness ratio to the main oblique grooves 16A, 16B. As variants, the slenderness ratio of the secondary oblique grooves differs from that of the main oblique grooves 16A, 16B.

1.-15. (canceled)

16. A tire comprising a directional tread, the tread comprising a central axis and two edges flanking the central axis and determining a tread width W, the tread width W being greater than or equal to 140 mm, the tread comprising a plurality of patterns which succeed one another in a circumferential direction, each pattern having a pitch P, the patterns delimiting a plurality of oblique grooves, each oblique groove extending from one of the edges of the tread as far as the central axis,
wherein, in a central part of the tread centered on the central axis and of a width corresponding to 80% of the width W of the tread, all or some of the oblique grooves of the plurality of oblique grooves have a slenderness ratio E between 0.85 and 1.5, the slenderness ratio corresponding to a ratio between a projected length Lpx of the oblique groove in the circumferential direction and half the width of the central part of the tread, such that
$$E = \frac{L p x}{0.4 * W} ,$$
and
wherein all or some of the patterns comprise at least one sipe, a sipes density SD in all or some of these patterns being between 10 mm⁻¹ and 70 mm⁻¹, the sipes density SD corresponding to a ratio between a sum of a projected length lpyi of the at least one sipe in an axial direction to a product of the pitch P of the pattern and of the width W of the tread, all then multiplied by 1000, such that
$$SD = \frac{{\sum }_{i = 1}^{n} lpyi}{P * W} * 1000 ,$$
where n is a number of sipes in the pattern.

17. The tire according to claim 16, wherein the tread comprises different pattern types Mj, where j is greater than or equal to 2, the patterns belonging to the one same pattern type having the one same pitch, the pitch between patterns belonging to two different pattern types being different, and
wherein a mean sipes density SDmean is between 10 mm⁻¹ and 70 mm⁻¹, the mean sipes density SDmean corresponding to a mean of the sipes densities SDj of the patterns of the different pattern types Mj over an entire circumference of the tread, the mean sipes density SDmean being weighted according to a number of patterns Nj per pattern type Mj and according to a pitch Pj of the patterns belonging to that pattern type Mj over the circumference of the tread, such that
$$SD mean = \frac{{\sum }_{j = 1}^{m} ( SDj * N j * P j )}{{\sum }_{j = 1}^{m} ( Nj * P j )} ,$$
where SDj is the sipes density in a pattern belonging to the pattern type Mj, Pj is the pitch of the patterns belonging to the pattern type Mj, and Nj is the number of patterns belonging to the pattern type Mj.

18. The tire according to claim 16, wherein the sipes density SD is greater than 25 mm⁻¹, less than 50 mm⁻¹, or both greater than 25 mm⁻¹ and less than 50 mm⁻¹.

19. The tire according to claim 16, wherein the sipes density SD is between 30 mm⁻¹ and 40 mm⁻¹.

20. The tire according to claim 16, wherein each pattern comprises a set of blocks comprising at least one block, and
wherein the at least one block has a maximum radial height Hmax when new that is between 5.5 mm and 9 mm.

21. The tire according to claim 20, wherein each pattern comprises at least two adjacent blocks, the number of sipes in each block being greater than or equal to one sipe, and
wherein the number of sipes, the arrangement of sipes, or both the number and arrangement of sipes differs between two adjacent blocks.

22. The tire according to claim 20, wherein the at least one block is made of a rubbery material, and
wherein a composition of the rubbery material has a glass transition temperature Tg between −40° C. and −10° C. and a dynamic complex shear modulus G* measured at 60° C. between 0.5 MPa and 2 MPa.

23. The tire according to claim 20, wherein a composition of the at least one block comprises an elastomer compound, the elastomer compound containing a modified diene elastomer containing at least one functional group comprising a silicon atom, the silicon atom being situated within a main chain of the elastomer, including ends of the chain.

24. The tire according to claim 23, wherein the modified diene elastomer containing a functional group comprising a silicon atom is a modified elastomer containing at least one silanol functional group situated at one end of the main chain of the modified elastomer.

25. The tire according to claim 23, wherein the modified diene elastomer containing a functional group comprising a silicon atom is a modified elastomer containing, within its structure, at least one alkoxysilane group bonded to the modified elastomer via the silicon atom, and at least one functional group comprising a nitrogen atom.

26. The tire according to claim 25, wherein the modified diene elastomer is predominantly functionalized in the middle of the chain by an alkoxysilane group bonded to the two branches of the modified diene elastomer via the silicon atom.

27. The tire according to claim 25, wherein the modified diene elastomer exhibits at least two of the following characteristics:
the functional group comprising a nitrogen atom is a tertiary amine;
the functional group comprising a nitrogen atom is borne by the alkoxysilane group via a spacer group defined as an aliphatic C1-C10 hydrocarbon-based radical; and
the alkoxysilane group is a methoxysilane or an ethoxysilane, optionally partially or completely hydrolyzed to give silanol.

28. The tire according to claim 23, wherein the modified diene elastomer is a butadiene/styrene copolymer.

29. The tire according to claim 23, wherein the modified diene elastomer exhibits a glass transition temperature within a range extending from −105° C. to −70° C.

30. The tire according to claim 16, wherein the tire has a 3PMSF winter certification, the certification being indicated on a sidewall of the tire.
